(19) United States
(12) Patent Application Publication
(10) Pub. No.: US 2006/0103727 A1
(43) Pub. Date: May 18, 2006

(54) Vehicle back up camera

(76) Inventor: Huan-Chin Tseng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/989,356

(22) Filed: Nov. 17, 2004

(51) Int. Cl. H04N 5/225; H04N 7/18; H04N 9/47

(52) U.S. Cl. 348/148; 348/373

(57) ABSTRACT

A separate vehicle back up camera has a photo-device, at least one electric wire, a circuit board and a signal wire. The at least one electric wire connects the photo-device to the circuit board. The signal wire connects to the circuit board to transmit signal inside the vehicle. The photo-device and the circuit board are mounted separately in the vehicle so the photo-device can be concealed well and will not detract from the appearance of the vehicle.

### BACKGROUND OF THE INVENTION

1. Field of the Invention

The present invention relates to a camera, particularly to a vehicle back up camera.

2. Description of the Prior Arts

Some vehicles, especially automobiles, have a back up camera mounted on the rear bumper to detect obstacles out of the driver's field of vision when the vehicle is parking. With reference to FIG. 3, the conventional back up camera comprises a circuit board (50), an image sensor (501), a filter (502), a camera lens (51), a wire (70) and a casing (60). The image sensor (501) is attached to the circuit board (50). The filter (502) is attached to the image sensor (502). The camera lens (51) is attached to the filter (502). The wire (70) is connected to the circuit board (50). The casing (60) comprises a waterproof housing (61) and a cover (62). The waterproof housing (61) has a cylinder (612) and a lens (611). The cylinder (612) is formed on the waterproof housing (61) and houses the camera lens (51). The lens (611) is attached to the cylinder (612) and corresponds to the camera lens (51). The cover (62) is mounted over the waterproof housing (61) and has a through hole (621) corresponding to the lens (611). The conventional back up camera is sealed unit, and the various components cannot be used separately. Therefore the conventional back up camera needs a large waterproof housing to cover all the components and occupies a large volume. The conventional back up camera is difficult to conceal and will detract from the appearance of the vehicle.

To overcome the shortcomings, the present invention provides a separate vehicle back up camera that has separable components to mitigate or obviate the aforementioned problems.

### SUMMARY OF THE INVENTION

The main objective of the present invention is to provide a separate back up camera for a vehicle, particularly an automobile. The separate vehicle back up camera has a photo-device, at least one electric wire, a circuit board and a signal Wire. The at least one electric wire connects the photo-device to the circuit board. The signal wire connects to the circuit board to transmit signals inside the vehicle. The photo-device and the circuit board are mounted separately in the vehicle so the photo-device can be concealed well and not detract from the appearance of the vehicle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a separate vehicle back up camera in accordance with the present invention;

FIG. 2 is a perspective view of the separate back up camera in FIG. 1 mounted on an automobile; and

FIG. 3 is an exploded perspective view of a conventional back up camera in accordance with the prior art.

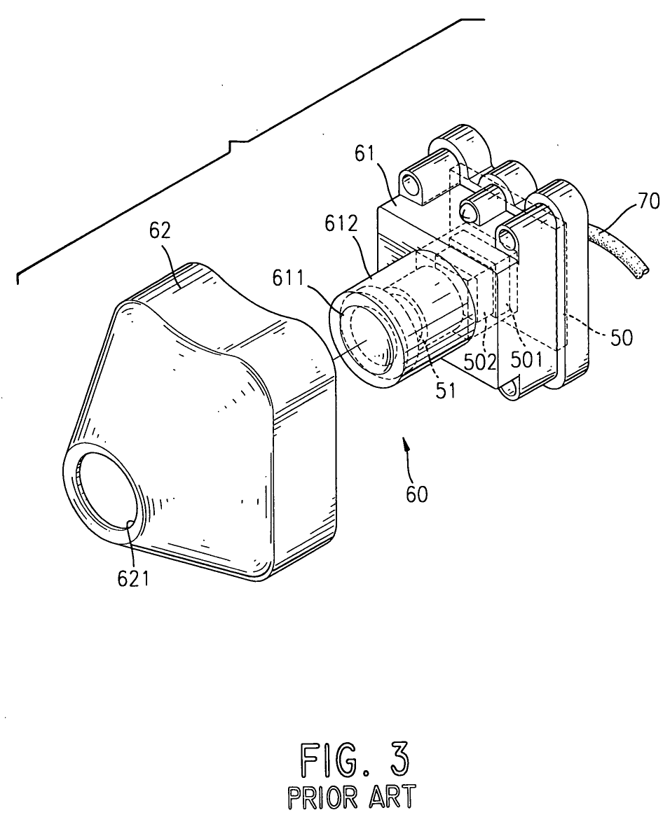

### DETAILED DESCRIPTION OF THE PREFERRED EMBODIMENTS

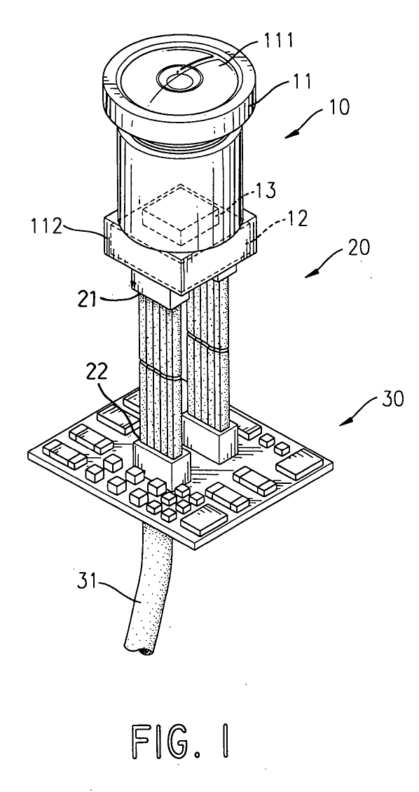

With reference to FIG. 1, a separate vehicle back up camera in accordance with the present invention comprises a photo-device (10), a circuit board (30), at least one electric wire (20) and a signal wire (31).

The photo-device (10) comprises a distal end, a proximal end, a head (11), a lens (111), a sensor recess (112), a sensor (12) and a filter (13). The head (11) is formed on the distal end. The lens (111) is mounted securely in the head (11). The sensor recess (112) is formed in the proximal end. The sensor (12) is mounted securely in the sensor recess (112) and may be a charge coupled device (CCD). The filter (13) is attached to the sensor (12).

The circuit board (30) has an input side and an output side.

Each electric wire (20) connects the photo-device (10) to the circuit board (30) and has an input end (21) and an output end (22). The input end (21) connects to the sensor (12). The output end (22) connects to the input side of the circuit board (30). In the preferred embodiment, the back up camera has two electric wires (20).

The signal wire (31) connects to the output side of the circuit board (30) to transmit signals inside the vehicle.

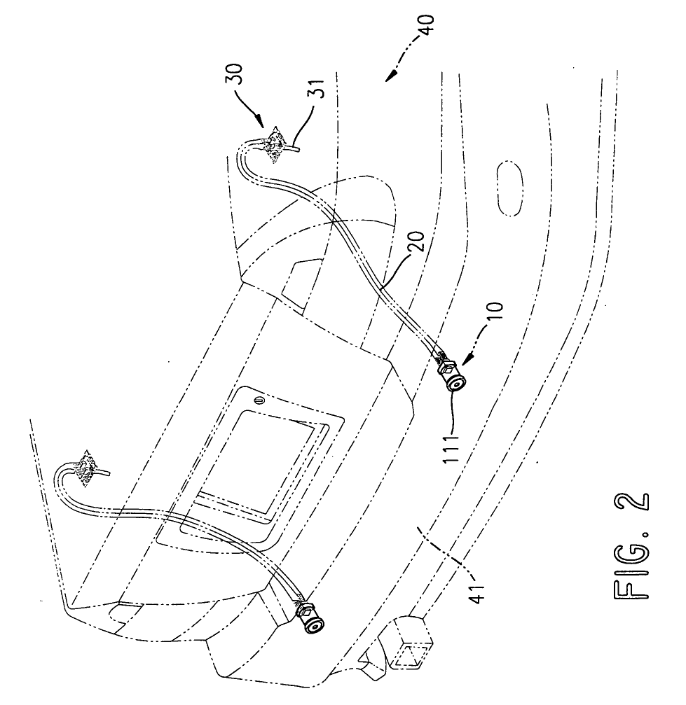

With further reference to FIG. 2, the separate back up camera is mounted in an automobile (40). The automobile (40) has a rear end and a rear bumper (41). The rear bumper (41) is attached to the rear end of the automobile (40). The photo-device (10) is mounted in the rear bumper (41). The circuit board (30) is mounted inside the automobile (40). Because the at least one electric wire (20) connects the photo-device (10) to the circuit board (30), the photo-device (10) and the circuit board (30) can be mounted in different locations in the automobile (40). Therefore the photo-device (10) can be well concealed and will not detract from the appearance of the automobile (40).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A separate back up camera for a vehicle comprising
a photo-device comprising
a distal end;
a proximal end;
a head formed on the distal end;
a lens mounted securely in the head;
a sensor recess formed in the proximal end;
a sensor mounted securely in the sensor recess; and
a filter attached to the sensor;
a circuit board having
an input side; and
an output side;
at least one electric wire connecting the photo-device to the circuit board and having
an input end connecting to the sensor; and
an output end connecting to the input side of the circuit board; and
a signal wire connecting to the output side of the circuit board to transmit signals inside the vehicle.

2. The separate back up camera as claimed in claim 1 wherein the sensor is a charge coupled device (CCD).

3. The separate back up camera as claimed in claim 1 comprising two electric wires.

4. The separate back up camera as claimed in claim 2 comprising two electric wires.
